(19) United States
(12) Patent Application Publication
(10) Pub. No.: US 2011/0162894 A1
(43) Pub. Date: Jul. 7, 2011

(54) STYLUS FOR TOUCH SENSING DEVICES

(75) Inventor: Douglas Weber, Arcadia, CA (US)

(73) Assignee: Apple Inc., Cupertino, CA (US)

(21) Appl. No.: 12/683,287

(22) Filed: Jan. 6, 2010

(51) Int. Cl. G06F 3/044; G06K 11/06

(52) U.S. Cl. 178/19.03

(57) ABSTRACT

A stylus for entering data on a touch-screen computing device. The stylus includes a conductive tip that creates capacitive coupling between the stylus and the touch-screen of the computing device. The conductive tip may also be heated and include a passive or active heating element. Additionally, a dock for the stylus may be provided for the computing device to recharge the battery of the stylus and also provide storage for the stylus when not in use.

### CROSS-REFERENCE TO RELATED APPLICATIONS

This application incorporates the application titled “Communicating Stylus,” identified as attorney docket no. P7972US1 (P201559.US.01) and filed on Jan. 6, 2010, as if set forth herein in its entirety.

### TECHNICAL FIELD

Embodiments relate generally to input apparatuses for computing devices, and more particularly to a stylus used for entering data into a computing device.

### BACKGROUND

There are a number of different options for entering data into a computing device. For instance, a keyboard, mouse, stylus, or touch screen may each be used for data entry. Some touchscreen computing devices, such as mobile phones, tablet personal computers, personal digital assistants and so forth, allow a user to use a finger to enter data. Some other types of computing devices also allow a user to enter data using a resistive-tip plastic stylus.

The touchscreens in some computing devices employ one or more capacitive sensors which allow the screen to recognize when a user's finger is selecting or entering data. However, one problem is that many current styluses operate with resistive touchscreens but do not function with a capacitive device, insofar as a touch of the stylus does not change the capacitance sensed by such a device. Thus, many user enter data into a device having a capacitive touch screen by touching or tapping the screen with a finger. As a user's finger is relatively wide, it may be difficult for the user to enter more complex text and characters, such as characters in Asian languages.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One embodiment is a conductive stylus for entering data into a capacitive-coupling computing device, such as a touch-screen. The stylus in one embodiment has a conductive tip. In another embodiment the conductive tip of the stylus may be heated, creating a more consistent interaction between the capacitive-sensors in the computing device and the stylus. Additionally, in yet another embodiment the stylus includes a rechargeable battery which may be recharged through a docking station located on the computing device.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 illustrates a first embodiment of a stylus that may be used to enter data into a computing device;

FIG. 2a illustrates a side view of the embodiment of FIG. 1;

FIG. 2b illustrates a side view of a second embodiment of a stylus;

FIG. 3a illustrates a cross-sectional internal view of another embodiment;

FIG. 3b illustrates a side internal view of the second embodiment;

FIG. 4 illustrates a top planar view of a stylus docked to an electronic device;

FIG. 5 is a flowchart for operating an embodiment in conjunction with a dock;

FIG. 6 is a flowchart for operating an embodiment with a heating element; and

FIG. 7 is a block diagram illustrating a computing system which may operate in conjunction with one or more of the embodiments disclosed herein.

### DETAILED DESCRIPTION

Aspects of embodiments discussed herein include systems, apparatuses, and methods that embody and/or use a stylus with a touch-sensing computing device. One embodiment may take the form of a conductive stylus that capacitively couples to a capacitive-sensing touch screen computing device, when the tip of the stylus touches or is sufficiently near the device. The tip may be a ball or otherwise have a rounded tip. In one embodiment, the tip is made of metal or other type of conductive material. The tip may also be coated with a thin protective layer, such as plastic. The layer may prevent the screen of the computing device from being scratched, while also allowing capacitive coupling to occur.

In another embodiment, the tip may be heated to create a more consistent interaction with the capacitive screen, since heating the stylus tip may offset instability of capacitance due to aging. The tip may be heated in a number of ways. For example, a battery powered heating element, a heat sink which transfers the heat from a user's hand to the tip, and/or a fluid-based heating element may all be used. Additionally, if the heating element is battery powered, the stylus may mate with a docking station that charges the battery.

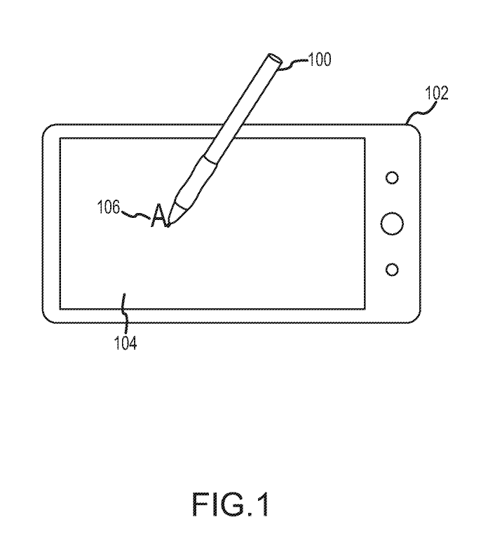

Referring now to FIG. 1, in one embodiment the stylus 100 may be used to write text 106 on the screen 104 of a computing device 102. The stylus 100 may enter in any type of text 106 drawings or characters, limited generally by the width of the stylus tip, the minimum sensing capability of the device and/or the size of the screen. The stylus tip may capacitively couple to the device (or to the screen of the device), thereby allowing the device to sense the stylus' presence.

The computing device 102 detects and receives the input from the stylus 100 through this capacitive coupling (and optionally via the screen 104), processes the data and then sends the data back to the screen 104 to display. Often, this takes the form of displaying a graphic or differently-colored pixel where input is detected. Thus, as the stylus moves across the screen, it may leave behind a trail much like the ink left by a pen. The computing device 102 may be any type of device that is able to receive a capacitive input. For example, a touch screen computer, a personal digital assistant, a cellular phone or a smart-phone. It should also be noted that the stylus need not directly touch the device or screen; the device and/or screen may be sufficiently sensitive to detect a capacitive change across an air gap as the stylus draws near.

The screen 104 provides a surface on which the stylus may write or draw in this fashion, as well through which the stylus may select one or more options displayed on the screen 104. The screen 104 thus may act as an input and/or output interface between the computing device 102 and the user. In one embodiment, the screen has a touch-sensitive surface. That is, the screen includes a sensor or set of sensors that accepts input from the user based on contact or proximity. Generally, these capacitive sensors may be arrayed in a pattern, such as a grid, beneath a dielectric layer such as glass and above a ground plane. The sensors may be arranged in a row and column format to detect input through changes in capacitance sensed by a sensor at the intersection of each row and column. Alternative arrangements may also be employed as appreciated by those skilled in the art. In short, the screen 104 may detect contact and any movement using any of a plurality of touch sensing technologies now known or later developed, including but not limited to capacitive, resistive, infrared, and surface acoustic wave technologies, as well as other proximity sensor arrays or other elements for determining one or more points of contact between the touch screen and stylus.

A display layer forms part of the screen 104 as well. The display may be below the glass layer and may utilize any of a variety of technologies. For example, the screen 104 may use liquid crystal display technology, light-emitting diodes, organic light-emitting diodes, and/or light emitting polymer display technology, although other display technologies may be used in other embodiments.

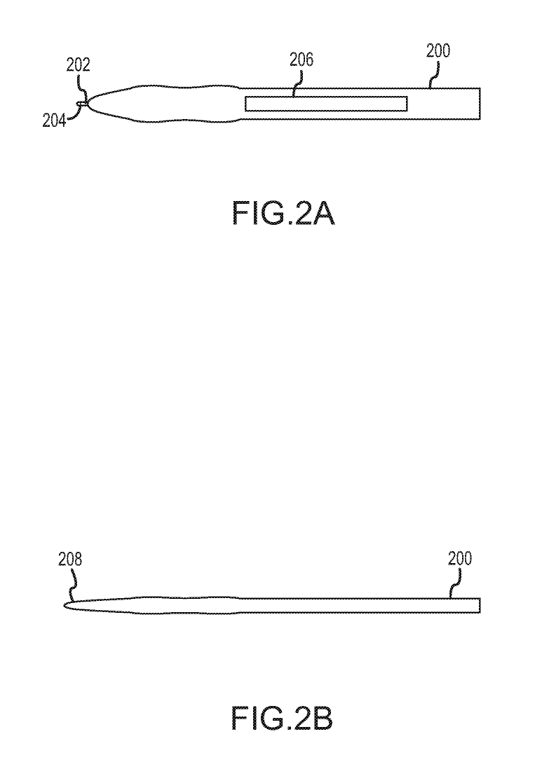

Referring now to FIG. 2a, in one embodiment the stylus has a body 200, a tip 202, a grip portion 206 and a tip coating 204. One or more of these parts, such as the grip portion, may be omitted in alternative embodiments. The body 200 may be held anywhere by the user while using the stylus to input data. The body 200 is connected to the tip 202 physically at one end but may also be electrically coupled to the tip 202. A lead or trace may extend from the tip, throughout the body, and ultimately to a surface in contact with the user's hand when the user holds the stylus. For example, the lead may connect the tip to the grip portion (as shown by the dashed line in FIG. 2A. In this manner, the capacitance of the tip may be increased to a point sufficient to be detected by the touch screen or other electronic device with which the stylus interacts. The lead may be partially or completely encircled by the body. In some embodiments, portions of the lead may be exposed to form the grip portion or to couple the tip to the user. In other embodiments, the tip and body are electrically connected and no separate lead is used.

The body 200 may include a separate grip 206 portion. As mentioned, when the body 200 and tip 202 are electrically coupled together the tip 200 may be grounded to the user. The body 200 may be hollow, solid or partially solid. The body 200 may enclose additional elements included in other embodiments of the stylus 100, as discussed below. The body 200 may be made out of any material, such as plastic, metal, fabric, leather or the like or may be a combination of any of the above materials. For instance, the body 200 may be mostly leather, but include a user grip portion 206 made from metal or another electrically conductive substance. In such an embodiment, the grip portion 206 may be the only portion of the body 200 electrically coupled to the tip 202. The grip portion 206 may be omitted, and may only be included if the body 202 is constructed out of a non-conducting material.

The tip 202 is used to capacitively couple to the screen 104, allowing the user to input data through the screen. Typically, this data input takes the form of a tap or motion along the screen surface, such as a line or drawing a letter. The tip 202 may be a rotating ball fit into a socket in the body 202 or may be a fixed, rounded end. The tip 202 may be made out of any material that has some conductivity, such as copper, aluminum, gold, silver or other metals, graphite or other non-metallic conductors. The tip 202 may also be formed of a soft conductive material, such as an elastomer, that as been doped with metal or other conductive particles. A soft conductive material may allow the tip 202 to avoid scratching the screen 104 while still capacitively coupling with the screen 104.

In one embodiment, the stylus tip 202 includes a coating 204. The coating 204 covers the tip 202 in order to protect the tip 202 from scratching the screen 104, it may cover the tip 202 either completely or partially. The coating 204 is thin enough to allow the tip 202 to produce capacitive coupling when making contact with the screen 104, but thick enough to provide a layer of protection. The coating 204 may be formed of plastic, silicon, rubber or the like. Additionally, the tip 202 may function without the coating 204.

Referring now to FIG. 2b, in another embodiment the tip 206 of the stylus is formed integrally with the body 200. In this embodiment the tip 206 is the end of the body 200 and they are formed from one piece. In this case the tip 206 may be constructed from the same material as the body 200. If the material is electrically conductive, then the tip may be electrically coupled to a user when the user gasps the body of the stylus.

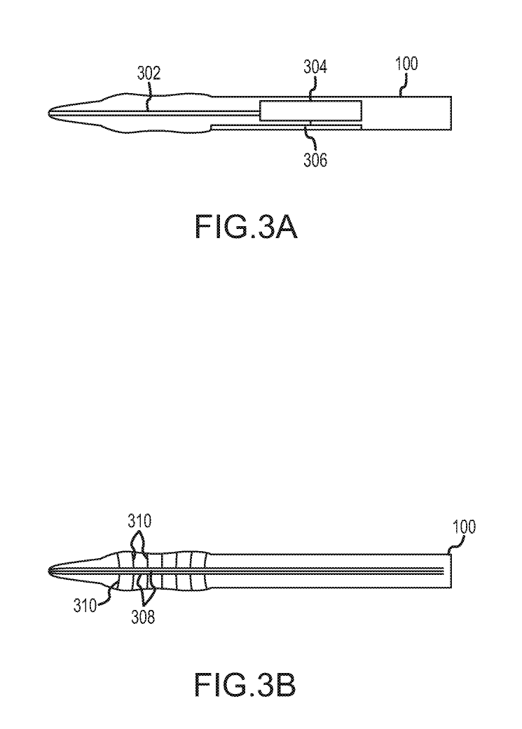

Referring now to FIG. 3A, in one embodiment the stylus 100 includes a heating element 302, a battery 304, and a touch sensor 306. The heating element 302 supplies heat to the tip 202. When the tip 202 is heated by the heating element 302, it may stabilize or enhance the capacitance of the stylus, thus permitting the screen 104 to more easily recognize that the stylus 100 is entering data. Typically, the sensors in the device 102 or screen 104 are better able to recognize a constant temperature versus varying temperatures or unpredictable temperatures. In one embodiment, the heating element 302 heats the tip 202 to approximately body temperature, e.g., 37° Celsius (98.6° Fahrenheit). The heating element 302 may near-instantaneously heat the tip or may heat the tip over time. Likewise, the heating element may maintain the tip temperature even when the stylus is not in use or may heat the stylus only when the stylus is grasped, removed from its dock, or when the tip comes in contact with a surface.

The heating element 302 may be located inside the body 200 of the stylus and may be electrically connected to the battery 304 and the tip 202. The heating element 302 may be anything capable of providing a source of heat, such as a resistor or fluid. For instance, the heating element may take the form of a resistive wire made from materials such as a metal or metal alloy (e.g., Nichrome, Kanthal, Cupronickle, and so on); metal bars or wires, wire insulated in steel or brass, ceramics with positive thermal coefficients, fluid or the like. In one embodiment, the heating element 302 may heat a fluid that circulates to provide heat to the tip. In this embodiment the fluid for the heating element is stored in the same manner as ink is stored in a liquid-ink pen, for example, inside a plastic tube disposed within the body 200.

The battery 304 generally supplies power to the heating element 302 and may be located within the body 200 of the stylus. The battery 304 is electrically connected to the heating element 302 and may also be electrically connected to a touch sensor 306. The battery 304 may be any type of battery, such as nickel-cadmium, nickel-metal hydride, lithium ion, polymer, alkaline or lead-acid. Additionally, the battery 304 may be rechargeable or a single use.

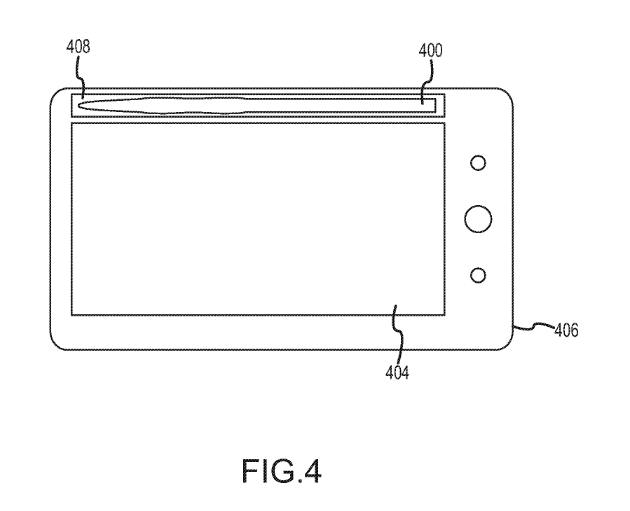

A touch sensor 306 senses when the stylus 100 is being grasped by the user. The touch sensor 306 may be located anywhere on the body 200 of the stylus, and is electrically coupled to the battery 304. The touch sensor 306 may be any type of electronic element which can detect a user's touch, such as a temperature sensor, a resistance sensor, a capacitive sensor, a pressure sensor, and the like. The touch sensor 306 may instead be a switch that is flipped or activated by the user, or a switch that automatically detects when the body 202 is removed from the dock. (See FIG. 4 and the description below for more information regarding the dock.)

The touch sensor 306, when activated by the user, sends a signal to the battery 304 that the stylus is being held. The battery 304 may then activate the heating element 302. The heating element 302 then provides heat to the tip 202, allowing the tip 202 to reach a constant temperature. In one embodiment, the temperature reached by the tip 202 is approximately body temperature, i.e. 37° Celsius (98.6° Fahrenheit). It should be noted that the touch sensor is optional and may be omitted from certain embodiments.

Referring now to FIG. 3B, in another embodiment the stylus 100 includes a passive heating element 308. In this embodiment, the battery 304 and touch sensor 306 may be omitted. The passive heating element 308 may automatically activate when the user grips the stylus 100. As one example, the passive heating element may extend to the outside of the body and come in contact with a user's hand through radially-extending elements 310, as shown in FIG. 3B. The passive heating element 308 may be designed as a heat sink to transfer thermal energy from the user's hand to the tip 202. The passive heating element 308 may be constructed out of bars, wires, cylinders or other shapes. Sample materials that may be used to implement the passive heating element include copper, aluminum, gold and other thermally-conductive metals, carbon-doped metals or metals doped with another element to increase thermal conductivity, composite materials, ceramics, and so on. In certain embodiments, an appropriate thermally-conductive fluid may be used to implement the passive heating element 308.

Referring now to FIG. 4, in another embodiment a battery in the stylus 400 may be recharged through a dock located on (or associated with) a computing device 406. The computing device 406 includes a screen 404 and a dock 408. The dock 408 holds the stylus 400 in place when the user is not using it. The dock 408 may be formed integrally with the case of the computing device 406 or may be an add-on input/output device to the computing device 406. The dock 408, in one embodiment, includes a lock-type mechanism for holding the stylus 400 in place, so that it does not fall out while the computing device 406 is being transported or used. The lock mechanism may be a set of plastic tabs or any similar device capable of holding and easily releasing the stylus 400. In an alternative embodiment the dock 408 may be an inductive charger, which uses an electromagnetic field to transfer energy between the battery 304 and the dock 408. In one embodiment the stylus 400 provides a signal to the touch sensor 306 when it is removed from the dock 408. This allows the touch sensor 306 to activate the heating element 304 when the user removes the stylus 400 from the dock 408. The signal may be provided wirelessly from the stylus. Further, the dock may detect the removal of the stylus and activate the electronic device 406 (for example, by turning it on).

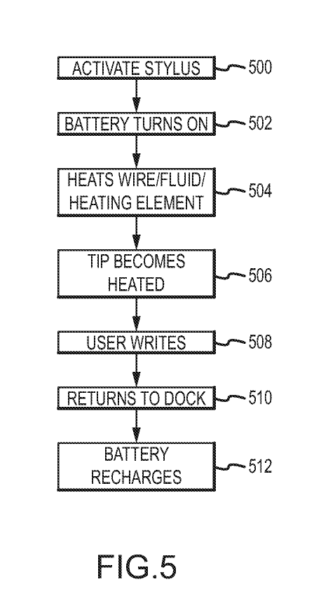

FIG. 5 illustrates a flowchart for one embodiment of the stylus 100. In the first operation 500 the stylus is activated. This may be done automatically when the user either touches the touch sensor 306 or removes the stylus 100 from the dock 408. Alternatively, the first operation 500 may be done manually by the user. For example, by pressing a button or switch linked to the touch sensor 306. After the stylus has been activated, the battery turns on, as illustrated in the operation 502. In the operation 502, the battery 304 activates based on a signal from the touch sensor 306 that the stylus has been activated. In operation 504 the battery 304 provides power to and thereby warms the heating element 302. In operation 506 the heating element 302 provides heat to the tip 202, which in return heats up. Operation 506 may be performed essentially instantaneously with the operation 504, in certain embodiments. In operation 508, the user may input data with the stylus by touching (or nearly touching) the tip 202 to the screen 104, producing capacitive coupling between the stylus 100 and the screen 104. In one embodiment, in operation 510 the user completes writing and returns the stylus 100 to the dock 408. Operation 510 may be omitted if, for example, the computing device 106 does not have a dock 408 for the stylus. Once the stylus has been returned to the dock 408, in operation 512 the battery 304 recharges via the dock 408.

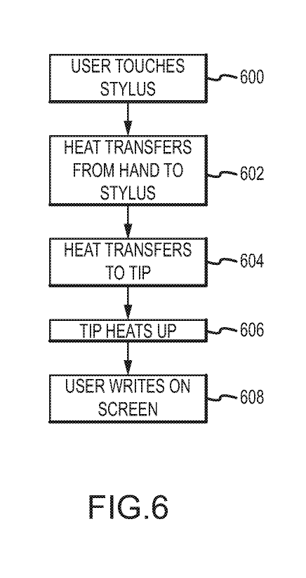

FIG. 6 illustrates a flowchart for another embodiment of the stylus 100. Initially, in operation 600 the user grasps the stylus 100 in order to begin writing, drawing or otherwise entering data into the screen 104. In operation 602 heat transfers from the user's hand holding the stylus to the body 200. This may begin to happen as soon as the user touches the stylus 100. In operation 604, the heat from the user's hand transfers from the body 200 to the tip 202. Operation 604 is generally accomplished through the heating element 302 or the passive heating element 308. In operation 606 the tip 202 heats up. Next, in operation 608 the user may input data via the screen 104 with the tip 202.

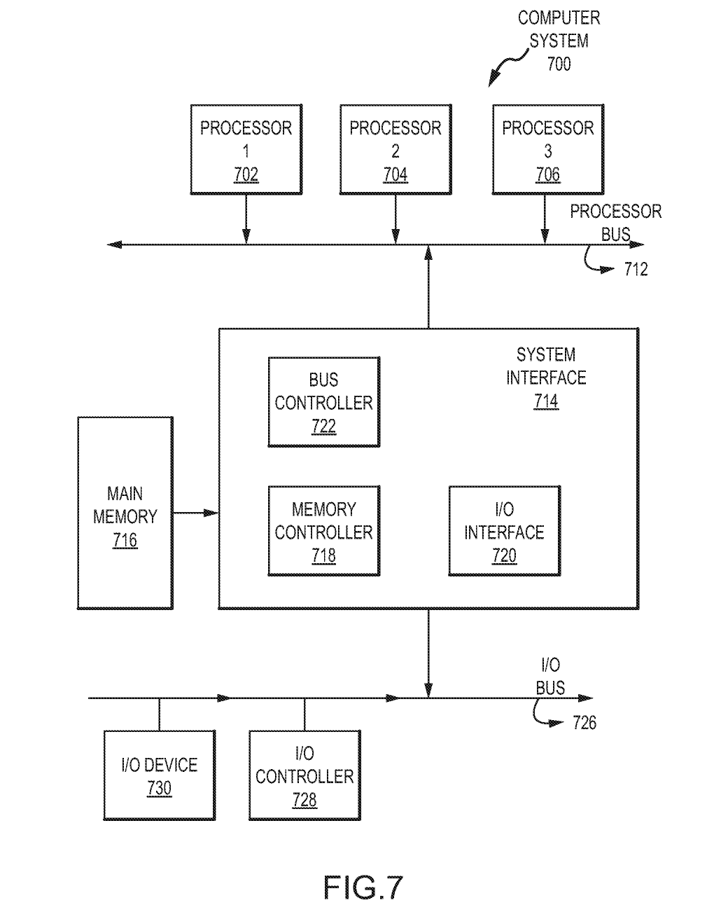

FIG. 7 is a block diagram illustrating an example of a computer system device 700 which may be used in or with certain embodiments. In general, the computing device 106 and stylus 100 may include or omit any of the described components. In FIG. 7, the computer system includes one or more processors 702-706. Processors 702-706 may include one or more internal levels of cache (not shown) and a bus controller or bus interface unit to direct interaction with the processor bus 712. Processor bus 712, also known as the host bus or the front side bus, may be used to couple the processors 702-706 with the system interface 714. System interface 714 may be connected to the processor bus 712 to interface other components of the system 700 with the processor bus 712. For example, system interface 714 may include a memory controller 718 for interfacing a main memory 716 with the processor bus 712. The main memory 716 typically includes one or more memory cards and a control circuit (not shown). System interface 714 may also include an input/output (I/O) interface 720 to interface one or more I/O bridges or I/O devices with the processor bus 712. One or more I/O controllers and/or I/O devices may be connected with the I/O bus 726, such as I/O controller 728 and I/O device 730, as illustrated.

I/O device 730 may also include an input device (not shown), such one that communicates with the stylus 100, an alphanumeric input device, including alphanumeric and other keys for communicating information and/or command selections to the processors 702-706. Another type of user input device includes cursor control, such as a mouse, a trackball, or cursor direction keys for communicating direction information and command selections to the processors 702-706 and for controlling cursor movement on the display device. Additionally, the I/O device 730 may include a display screen, such as a liquid-crystal, plasma, light emitting diodes, vacuum florescent, surface-conduction electron-emitter display

System 700 may include a dynamic storage device, referred to as main memory 716, or a random access memory (RAM) or other devices coupled to the processor bus 712 for storing information and instructions to be executed by the processors 702-706. Main memory 616 also may be used for storing temporary

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

It should be noted that the flowcharts of FIGS. 5-6 are illustrative only. Alternative embodiments may add operations, omit operations, or change the order of operations without affecting the spirit and scope of the present disclosure.

1. A stylus comprising:
a body having a first end and a second end;
a tip located at a first end of the body, wherein the tip capacitively couples a user to an input device touched by the tip.

2. The stylus of claim 1 wherein the tip is metal.

3. The stylus of claim 1 wherein the tip is an elastomer doped with metal particles.

4. The stylus of claim 3 further comprising a coating surrounding the tip, wherein the coating is plastic.

5. The stylus of claim 1 further comprising a heating element, wherein the heating element is electrically coupled to the tip.

6. The stylus of claim 5 further comprising:
a battery contained within the body, wherein the battery is electrically coupled to the heating element.

7. The stylus of claim 6 wherein the heating element is a resistor.

8. The stylus of claim 1, further comprising:
a grip portion on the exterior of the body; and
a lead connecting the grip portion to the tip; wherein
the lead thereby grounds the tip to the grip portion.

9. The stylus of claim 8, wherein the lead grounds the tip to a user grasping the grip portion, thereby increasing the capacitance of the tip.

10. A method for entering data into a touch screen computing device, comprising:
activating a stylus, wherein the stylus comprises a tip and a body, the tip being disposed on a first end of the body;
electrically grounding the tip; touching the stylus to the touch screen, thereby entering data.

11. The method of claim 10, further comprising the operation of heating the tip.

12. The method of claim 11, wherein the operation of heating the tip is performed by a passive heat sink supplying heat from a user to the tip.

13. The method of claim 11, wherein the operation of heating the tip is performed by an active heating element supplying heat to the tip.

14. The method of claim 10 further comprising the operation of returning the stylus to a dock and recharging the stylus.

15. An apparatus for entering data into a computing device, comprising:
a body having a tip disposed at a first end of the body;
a touch sensor disposed along the length of the body;
a power source;
a heating element electrically connected to the tip; wherein
the tip is a conductive element and the tip is electrically connected to the body;
the power source is electrically connected to the touch sensor, and the touch sensor activates the power source; and
the heating element is connected near the tip and the heating element is electrically connected to the touch sensor and the power source.

16. The apparatus of claim 15 wherein the tip is made of metal.

17. The apparatus of claim 15 wherein the tip is an elastomer doped with metal particles.

18. The apparatus of claim 15 wherein the power source is a battery.

19. The apparatus of claim 15 wherein the heating element is a resistor.

20. The apparatus of claim 15, wherein the tip is capacitively coupled to a user.
